(19) United States
(12) Patent Application Publication
(10) Pub. No.: US 2022/0237088 A1
(43) Pub. Date: Jul. 28, 2022

(54) DISASTER RECOVERY

(71) Applicant: EMC IP Holding Company LLC, Hopkinton, MA (US)

(72) Inventor: Kevin Heasley, Dewey, AZ (US)

(73) Assignee: EMC IP Holding Company LLC, Hopkinton, MA (US)

(21) Appl. No.: 17/159,385

(22) Filed: Jan. 27, 2021

(51) Int. Cl. G06F 11/14; G06F 3/06; G06F 13/16

(52) U.S. Cl. CPC G06F 11/1469; G06F 11/1464; G06F 3/0619; G06F 2201/84; G06F 3/067; G06F 13/1668; G06F 2201/805; G06F 3/065

(57) ABSTRACT

One or more aspects of the present disclosure relates to disaster recovery of storage arrays. In embodiments, a consistent replica of input/output operations (IOs) received by a local storage array is asynchronously maintained at one or more remote storage arrays. The local storage array receives the first set of IOs during a first IO receive cycle. The first IO receive cycle occurs during a time interval, Further, the local storage array is located at a first site, and the remote storage arrays are located at a second site.

### BACKGROUND

Organizations can use a storage array to store their data. A storage array also called a disk array, is a data storage system for block-based storage, file-based storage, or object storage. Rather than store data on a server, storage arrays use multiple drives in a collection capable of storing a vast amount of data, managed by a central management system. An event can occur in some situations, such as a natural disaster that could destroy a data storage system. To mitigate data losses due to such an event, organizations can implement disaster recovery techniques to preserve as much data as possible.

### SUMMARY

One or more aspects of the present disclosure relates to disaster recovery of storage arrays. In embodiments, a consistent replica of input/output operations (IOs) received by a local storage array is asynchronously maintained at one or more remote storage arrays. The local storage array receives the first set of IOs during a first IO receive cycle. The first IO receive cycle occurs during a time interval, Further, the local storage array is located at a first site, and the remote storage arrays are located at a second site.

In embodiments, the time interval can be established based on 1) at least one historical and/or current IO workload received by the storage system and/or 2) a transmission time required to send each IO received during any given IO receive cycle to the one or more remote storage arrays. Additionally, a threshold geographical distance can separate the first and second sites.

In embodiments, a first set of IOs can be transmitted to the one or more remote storage arrays received during a first receive cycle. Further, a response can be received from the one or more remote storage arrays corresponding to the transmitted first set of IOs. Additionally, a second receive cycle can be started to receive a second set of IOs in response to receiving the response.

In embodiments, a remote data facility (RDF) link can be established between the storage system and the one or more host devices. A most recently completed IO cycle can further be transmitted to the remote storage arrays via the RDF link.

In embodiments, the remote storage arrays can be configured to establish a flash copy of a target storage device. The target storage device can store IOs related to one or more of the received IO cycles. The flash copy can be established based on a state of the RDF link.

In embodiments, a transmission time of IOs receiving during a receive cycle can be determined. A time required for the one or more remote storage arrays to process IOs related to a receive cycle that is prior to a receiving cycle related to a current transmission of IOs can also be determined.

In embodiments, triggering a receive cycle switch can be triggered based on the IO transmission and processing times.

In embodiments, a receive cycle switch interval can be established in response to determining that the IO transmission and/or IO processing times are less than a threshold. The a receive cycle switch interval can include receiving IOs during an n^{th} receive cycle, and transmitting IO related to an (n−1) receive cycle, wherein the one or more storage arrays are processing IO related to an (n−2) receive cycle.

In embodiments, a receive cycle switch interval can be established in response to determining that the IO transmission and/or IO processing times are greater than a threshold. The a receive cycle switch interval can include receiving an n^{th} receive cycle, an (n−1) receive cycle, and an (n−2) receive cycle, and transmitting an (n−y) receiving cycle, wherein the one or more storage arrays are processing IO related to an (n−(y−1)) receive cycle.

In embodiments, whether the state of the RDF link corresponds to a disaster event associated with a total loss of the storage system can be determined. Further, the flash copy can be established without pausing IO transmissions to the one or more remote storage arrays.

### BRIEF DESCRIPTION OF THE DRAWINGS

The foregoing and other objects, features, and advantages will be apparent from the following more particular description of the embodiments, as illustrated in the accompanying drawings. Like reference characters refer to the same parts throughout the different views. The drawings are not necessarily to scale, emphasis instead being placed upon illustrating the principles of the embodiments.

FIG. 1 illustrates a storage array system in accordance with the embodiments disclosed herein.

FIG. 2 is a block diagram of an Enginuity Data Services (EDS) controller in accordance with the embodiments disclosed herein.

FIG. 3 is a block diagram of a remote storage system in accordance with the embodiments disclosed herein.

FIG. 4 is a flow diagram of a method of asynchronously replicating a storage array in accordance with the embodiments disclosed herein.

FIG. 5 is a flow diagram of a method for storage array replication for disaster recovery in accordance with the embodiments disclosed herein.

### DETAILED DESCRIPTION

An event can occur in some situations, such as a natural disaster that could destroy an organization's data storage system. To mitigate data losses due to such an event, organizations can implement disaster recovery techniques to preserve as much data as possible. Disaster recovery techniques includes a set of policies, procedures, tools, and the like to enable the organization's recovery or continuation of vital technology infrastructure and systems following a natural or human-induced disaster.

Disaster recovery techniques can include establishing a global mirroring session between a local storage array and one or more remote storage arrays to mirror input/output operations (IOs) received by the local storage array. Current techniques require the global mirror session to be paused. For example, the local array can have a global mirroring session established with a first remote storage array. An organization may want to replicate the mirrored IOs on a second remote storage array. To perform the replication, current disaster recovery techniques must pause the global mirroring session between the local array and the first remote array.

Aspects of the present disclosure relate to one or more of the tools and techniques related to disaster recovery that enable such replication without pausing a local storage array's global mirroring session with a remote storage array. In embodiments, a consistent replica of a first set of input/output operations (IOs) received by a local storage array are asynchronously maintained at one or more remote storage arrays.

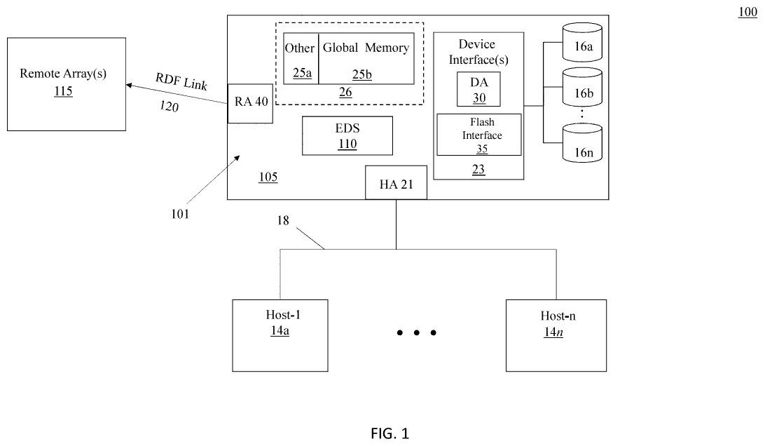

Regarding FIG. 1, an example system 100 includes a local data storage array 105 having one or more components 101 that perform one or more storage operations. The array 105 can communicatively couple to host systems 14a-n through communication medium 18. In embodiments, the hosts 14a-n can access the data storage array 105, for example, to perform input/output (IO) operations or data requests. The communication medium 18 can be any one or more of a variety of networks or other types of communication connections known to those skilled in the art. In embodiments, the communication medium 18 can be a network connection, bus, and/or other types of data link, such as a hardwire or other connections known in the art. For example, the communication medium 18 can be the Internet, an intranet, network (including a Storage Area Network (SAN)), or other wireless or other hardwired connection(s) by which the hosts 14a-n can access and communicate with the data storage array 105. The hosts 14a-n can also communicate with other components included in the system 100 via the communication medium 18. The communication medium 18 can be a Remote Direct Memory Access (RDMA) fabric that interconnects hosts 14a-n and the array 105 to form a SAN. The RDMA fabric can use a nonvolatile memory express (NVMe) communications protocol to send/receive data to/from the SAN devices.

The hosts 14a-n and the data storage array 105 can be connected to the communication medium 18 by any one of a variety of connections as can be provided and supported per the type of communication medium 18. The hosts 14a-n can include any one of a variety of proprietary or commercially available single or multi-processor systems, such as an Intel-based processor and other similar processors.

The hosts 14a-n and the data storage array 105 can be located at the same physical size or in different physical locations. The communication medium 18 can use various communication protocols such as SCSI, Fibre Channel, iSCSI, NVMe, and the like. Some or all the connections by which the hosts 14a-n and the data storage array 105 can connect to the communication medium can pass through other communication devices, such as switching equipment that can exist such as a phone line, a repeater, a multiplexer, or even a satellite.

Each of the hosts 14a-n can perform different types of data operations in accordance with different types of tasks. In embodiments, any one of the hosts 14a-n can issue a data request (e.g., an input/out (10) operation) to the data storage array 105. For example, an application executing on one of the hosts 14a-n can perform a read or write operation resulting in one or more data requests to the data storage array 105.

The storage array 105 can also include adapters or directors, such as an HA 21 (host adapter), and/or device interface 23. Each of the adapters, HA 21, RA 40, can be implemented using hardware, including a processor with local memory. The local memory 26 can store code that the processor can execute to perform one or more storage array operations. The HA 21 can manage communications and data operations between one or more of the host systems 14a-n. The local memory 26 can include global memory (GM) 27.

In an embodiment, the HA 21 can be a Fibre Channel Adapter (FA) or another adapter which facilitates host communication. The HA 21 can receive IO operations from the hosts 14a-n. The storage array 105 can also include one or more RAs (e.g., RA 40) that can, for example, facilitate communications between data storage arrays (e.g., between the storage array 12 and the external storage system(s)). The storage array 105 can also include one or more device interfaces 23 for facilitating data transfers to/from the data storage disks 16. The data storage interfaces 23 can include device interface modules, for example, one or more disk adapters (DAs) 30 (e.g., disk controllers), flash drive interface 35, and the like. The DA 30 can interface with the physical data storage disks 16.

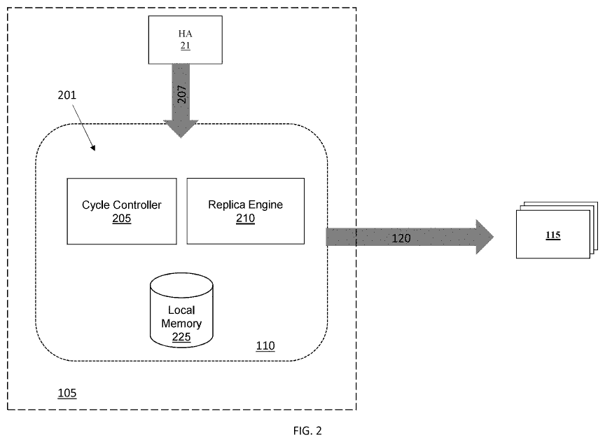

In embodiments, the storage array 105 can include one or more internal logical communication paths (e.g., paths 221, 222 of FIG. 2) between the device interfaces 23, the RAs 40, the HAs 21, and the memory 26. The communication paths can include internal busses and/or communication modules. For example, the GM 27 can use the communication paths to transfer data and/or send other communications between the device interfaces 23, HAs 21 and/or RAs 40 in a data storage array. In an embodiment, the device interfaces 23 can perform data operations using a cache that can be included in the GM 27, for example, when communicating with other device interfaces and other components of the data storage array. The local memory 26 can also include additional cache memory 28 can be a user-defined adaptable memory resource.

The host systems 14a-n can issue data and access control information through the SAN 18 to the storage array 105. The storage array 105 can also provide data to the host systems 14a-n via the SAN 18. Rather than presenting address spaces of the disks 16a-n, the storage array 105 can provide the host systems 14a-n with logical representations that can include logical devices or logical volumes (LVs) that represent one or more physical storage addresses of the disk 16. Accordingly, the LVs can correspond to one or more of the disks 16a-n. Further, the array 105 can include an Enginuity Data Services (EDS) processor 110. The EDS 110 can control the storage array components 111. In response to the array receiving one or more real-time 10 operations, the EDS 110 applies self-optimizing techniques (e.g., one or more machine learning techniques) to deliver performance, availability and data integrity services.

The storage disk 16 can include one or more data storage types. In embodiments, the data storage types can include one or more hard disk drives (HDDs) and/or one or more solid state drives (SSDs). An SSD is a data storage device that uses solid-state memory to store persistent data. An SSD that includes SRAM or DRAM, rather than flash memory, can also be referred to as a RAM drive. SSD can refer to solid-state electronics devices distinguished from electromechanical devices, such as HDDs, having moving parts.

The array 105 can enable multiple hosts to share data stored on one or more of the disks 16a-n. Accordingly, the HA 21 can facilitate communications between a storage array 105 and one or more of the host systems 14a-n. The RA 40 can be configured to facilitate communications between two or more data storage arrays. The DA 30 can be one type of device interface used to enable data transfers to/from the associated disk drive(s) 16a-n and LV(s) residing thereon. A flash device interface 35 can be configured as a device interface for facilitating data transfers to/from flash devices and LV(s) residing thereon. It should be noted that an embodiment can use the same or a different device interface for one or more different types of devices than as described herein.

In embodiments, the array 101 can include a RA 40 (remote adapter), the RA 40 can establish a remote data facility (RDF) communications link 120 between the local array 105 and one or more remote arrays 115. The local array 105 and the remote arrays 115 can be separated by a geographic distance. In examples, the geographical distance can correspond to a threshold distance. The threshold geographical distance can be selected to ensure that the remote arrays 115 are statistically unlikely to be affected by a disaster event that affects the local array 105 For example, the remote arrays 115 can be located at a distance greater than 100 or 150 kilometers (km) from the local array 105. Further, the RA 40 can establish and maintain a global mirroring session between the local array 105 and the remote arrays 115. The RA 40 can manage the global mirroring session to allow IOs received by the local array 105 to be mirrored on the remote arrays. 115.

Regarding FIG. 2, a storage array 105 can include an EDS processor 110 communicatively coupled to an HA 21, e.g., via a Fibre channel 207. It should be noted that the EDS 110 and/or any of its elements 201 (e.g., software and hardware elements) can be any one of a variety of commercially available processors, such as an Intel-based processor, and the like. Although the elements 200 are illustrated in the EDS 110, all or portions of the elements 200 can also reside elsewhere such as, for example, on HA 21, EDS 22, and RA 30 of FIG. 1. In other examples, the EDS 110 can be a parallel processor such as a graphical processing unit (GPU).

In embodiments, the host adapter 21 can include one or more ports (not shown) configured to receive IOs from one or more hosts devices 14a-n. To prevent complete data loss resulting from a disaster event, the EDS 110 can asynchronously maintain a consistent replication of the IOs received by the local array 105 as described in greater detail herein.

In embodiments, the EDS 110 can include a cycle controller 205 communicatively coupled to the HA 21 via, e.g., a communications interface 207. The communication interface 207 can include a Fibre channel or NVMe (Non-Volatile Memory Express) communication interface. Further, the controller 205 can include logic and/or circuitry configured to analyze the one or more IO workloads received by the HA 21. The analysis can include identifying one or more characteristics of each IO of the workload. For example, each IO can include metadata including information associated with an IO type, data track related to the data involved with each IO, time, performance metrics, and telemetry data, amongst other storage array IO related information. In further embodiments, the controller 205 can establish a communications session with the remote arrays 115. The controller 205 can establish the session via a communications link 120 (e.g., a remote data facility (RDF) link). In response to establishing the session, the controller 205 can determine a transmission latency related to a transmission of a set of IOs to the remote arrays 115.

In embodiments, the EDS 110 can establish one of more IO receive cycles, each corresponding to a time interval. The EDS 110 can associate each IO with the IO receive cycle corresponding to the time interval the HA 21 received each IO. The EDS 100 can establish the IO receive cycles based historical and/or current data resulting from its analysis of the one or more IO workloads and/or transmission latencies over the RDF link 120.

Based in the transmission latency, the EDS 110 can transmit IO received during one or more past receive IO cycles and initiate a current receive IO cycle. As such, the EDS 110 is able to maintain an asynchronous consistent replica of the local array 105 at the remote arrays 115. For example, the EDS 110 can determine whether IO transmissions and/or IO processing times are less than or greater than a threshold. The IO processing times can correspond to response times of the local array 105 and/or the remote arrays 115.

If the IO transmission and/or IO processing times are less than a threshold, the EDS processor 110 can establish a cycle switch interval that includes receiving IOs during an n^{th} receive cycle, and transmitting IO received during an (n−1)^{th} receive cycle. If the IO transmission and/or IO processing times are greater than a threshold and the remote arrays 115 are processing IOs received during an (n−y)^{th} receive cycle, the EDS processor 110 can establish a cycle switch interval that includes receiving an (n−2)^{th} receive cycle, an (n−1)^{th} receive cycle, and an n^{th} receive cycle. During or subsequent to the n^{th} receive cycle, the EDS 110 can transmit IOs received during an (n−y)^{th} receive cycle. For instance, the (n−2)^{th} receive cycle can correspond to an (n−(y+1))^{th} receive cycle.

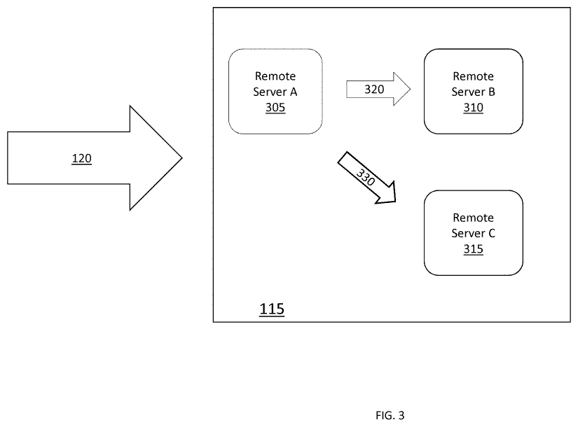

Regarding FIG. 3, the EDS 110 can configure the one or more remote storage arrays 115 to mirror IOs received by the local array 115. To that end, the EDS 110 can establish a global mirroring session between the local array 105 and the remote arrays 115 via an RDF link 120. The one or more remote arrays 115 can include a remote server A 305, remote server B 310, and remote server C 315. Each to the remote servers 305, 310, 315 can be located at a single remote data facility or geographically separated at unique remote data facility locations.

In embodiments, the EDS 110 can establish the remote server A as IO FlashCopy source of the local array's received IOs. Accordingly, the remote server A 305 performs data mirroring operations in response to receiving each of the local array's received IOs. Further, the EDS 110 can establish the remote server B 310 as a secondary FlashCopy target. The remote server B 310 can obtain a point-in-time FlashCopy of a most recent IO receive cycle mirrored by the remote server A 305. The remote server B 310 can obtain the FlashCopy on an on-demand basis. For instance, an operator may wish to perform a test of the replicated data and issue a request for a current consistent copy of the local array 105. In response to receiving the request, the server B 310 can obtain the point-in-time FlashCopy of a most recent IO receive cycle mirrored by the remote server A 305.

In embodiments, the EDS 110 can establish the remote server C 315 as a disaster recovery FlashCopy target. The EDS 110 can establish the server C 315 to become active in response to an indication of a disaster event. For instance, a disaster event can destroy the local array 105 resulting in the disruption of the global mirroring session via the RDF link 120 between the local array 105 and the remote array 115. In such circumstances, the disruption can cause the server C 315 to activate and obtain a point-in-time FlashCopy of a most recent IO receive cycle mirrored by the remote server A 305. Using the point-in-time FlashCopy, data stored by the local array 105 can be reproduced on another array with minimal data loss.

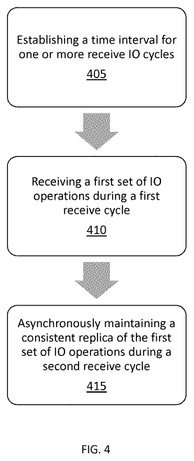

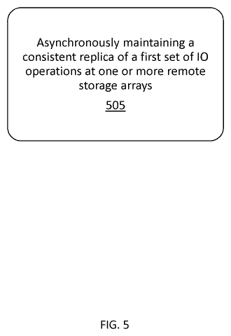

FIGS. 4-5 illustrate methods per one or more embodiments of this disclosure. For simplicity of explanation, FIGS. 4-5 depict and describe the methods as a series of acts. However, acts per this disclosure can occur in various orders and/or concurrently, and with other acts not presented and described herein. Furthermore, not all illustrated acts may be required to implement the methods in accordance with the disclosed subject matter.

Regarding FIG. 4, a method 400 can be executed by, e.g., the EDS 110. The method 400, at 405, can include Establishing a time interval for one or more receive IO cycles. Further, at 410, the method 400 can include receiving a first set of IO operations during a first receive cycle. At 415, the method 400 can include asynchronously maintaining a consistent replica of the first set of IO operations during a second receive cycle.

The method 400 can be performed according to any of the embodiments and/or techniques described by this disclosure, known to those skilled in the art, and/or yet to be known to those skilled in the art.

Regarding FIG. 5, a method 500 can be executed by, e.g., the EDS 110. The method 500, at 505, can include asynchronously maintaining a consistent replica of a first set of IO operations at one or more remote storage arrays.

The method 500 can be performed according to any of the embodiments and/or techniques described by this disclosure, known to those skilled in the art, and/or yet to be known to those skilled in the art.

Using the teachings disclosed herein, a skilled artisan can implement the above-described systems and methods in digital electronic circuitry, computer hardware, firmware, and/or software. The implementation can be as a computer program product. The implementation can, for example, be in a machine-readable storage device, for execution by, or to control the operation of, data processing apparatus. The implementation can, for example, be a programmable processor, a computer, and/or multiple computers.

A computer program can be in any programming language, including compiled and/or interpreted languages. The computer program can have any deployed form, including a stand-alone program or as a subroutine, element, and/or other units suitable for a computing environment. One or more computers can execute a deployed computer program.

One or more programmable processors can perform the method steps by executing a computer program to perform functions of the concepts described herein by operating on input data and generating output. An apparatus can also perform the method steps. The apparatus can be a special purpose logic circuitry. For example, the circuitry is an FPGA (field-programmable gate array) and/or an ASIC (application-specific integrated circuit). Subroutines and software agents can refer to portions of the computer program, the processor, the special circuitry, software, and/or hardware that implement that functionality.

Processors suitable for the execution of a computer program include, by way of example, both general and special purpose microprocessors and any one or more processors of any digital computer. Generally, a processor receives instructions and data from a read-only memory or a random-access memory, or both. For example, a computer's essential elements are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all nonvolatile memory forms, including semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by and/or incorporated in special purpose logic circuitry.

A computer having a display device that enables user interaction can implement the above-described techniques. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can provide for interaction with a user. Other devices can, for example, be feedback provided to the user in any form of sensory feedback (e.g., visual feedback, auditory feedback, or tactile feedback). Input from the user can, for example, be in any form, including acoustic, speech, and/or tactile input.

A distributed computing system that includes a back-end component can also implement the above-described techniques. The back-end component can, for example, be a data server, a middleware component, and/or an application server. Further, a distributing computing system that includes a front-end component can implement the above-described techniques. The front-end component can, for example, be a client computer having a graphical user interface, a Web browser through which a user can interact with an example implementation, and/or other graphical user interfaces for a transmitting device. The system's components can interconnect using any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. A client and server relationship can arise by computer programs running on the respective computers and having a client-server relationship.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 networks, 802.16 networks, general packet radio service (GPRS) network, HiperLAN), and/or other packet-based networks. Circuit-based networks can include, for example, a public switched telephone network (PSTN), a private branch exchange (PBX), a wireless network, and/or other circuit-based networks. Wireless networks can include RAN, Bluetooth, code-division multiple access (CDMA) network, time division multiple access (TDMA) network, and global system for mobile communications (GSM) network.

The transmitting device can include, for example, a computer, a computer with a browser device, a telephone, an IP phone, a mobile device (e.g., cellular phone, personal digital assistant (P.D.A.) device, laptop computer, electronic mail device), and/or other communication devices. The browser device includes, for example, a computer (e.g., desktop computer, laptop computer) with a world wide web browser (e.g., Microsoft® Internet Explorer® and Mozilla®). The mobile computing device includes, for example, a Blackberry®.

Comprise, include, and/, or plural forms of each are open-ended and include the listed parts and include additional elements that are not listed. And/or is open-ended and includes one or more of the listed parts and combinations of the listed features.

One skilled in the art will realize that other specific forms can embody the concepts described herein without departing from their spirit or essential characteristics. Therefore, the preceding embodiments are in all respects, illustrative rather than limiting the concepts described herein. Scope of the concepts is thus indicated by the appended claims rather than by the preceding description. Therefore, all changes embrace the meaning and range of equivalency of the claims.

1. A method comprising:
at one or more remote storage arrays, asynchronously maintaining a consistent replica of a local storage array's first set of input/output operations (IOs);
dynamically defining an IO receive cycle based on transmission latency measurements between the local and the one or more remote arrays; and
receiving the first set of IOs during a first IO receive cycle of the IO receive cycle at the local storage array;
initiating the first IO receive cycle occurs during a time interval; and
wherein the local storage array is located at a first site, and the remote storage arrays are located at a second site.

2. The method of claim 1 further comprising:
establishing the time interval based on 1) at least one historical and/or current JO workload received by the storage system and/or 2) a transmission time required to send each IO received during any given IO receive cycle to the one or more remote storage arrays; and
wherein a threshold geographical distance separates the first and second sites.

3. The method of claim 1 further comprising:
transmitting a first set of IOs to the one or more remote storage arrays received during a first receive cycle;
receiving a response from the one or more remote storage arrays corresponding to the transmitted first set of IOs; and
starting a second receive cycle to receive a second set of IOs in response to receiving the response.

4. The method of claim 3 further comprising:
establishing a remote data facility (RDF) link between the storage system and the one or more host devices; and
transmitting a most recently completed IO cycle to the remote storage arrays via the RDF link.

5. The method of claim 4 further comprising:
configuring the remote storage arrays to establish a flash copy of a target storage device, wherein:
the target storage device stores IOs related to one or more of the JO receive cycles, and
the flash copy is established based on a state of the RDF link.

6. The method of claim 5 further comprising:
determining a transmission time of IOs receiving during a receive cycle; and
determining a time required for the one or more remote storage arrays to process IOs related to a receive cycle that is prior to a receiving cycle related to a current transmission of IOs.

7. The method of claim 6 further comprising:
based on the IO transmission and processing times, triggering a receive cycle switch.

8. The method of claim 7 further comprising:
in response to determining that the IO transmission and/or IO processing times are less than a threshold, establishing a receive cycle switch interval by:
receiving IOs during an n^{th} receive cycle; and
transmitting IO related to an (n−1) receive cycle, wherein the one or more storage arrays are processing IO related to an (n−2) receive cycle.

9. The method of claim 7 further comprising:
in response to determining that the IO transmission and/or IO processing times are greater than a threshold, establishing a receive cycle switch interval by:
receiving an n^{th} receive cycle, an (n−1) receive cycle, and an (n−2) receive cycle; and
transmitting an (n−y) receiving cycle, wherein the one or more storage arrays are processing IO related to an (n−(y−1)) receive cycle.

10. The method of claim 7 further comprising:
determining whether the state of the RDF link corresponds to a disaster event associated with a total loss of the storage system; and
establishing the flash copy without pausing IO transmissions to the one or more remote storage arrays.

11. An apparatus, including a processor, configured to:
at one or more remote storage arrays, asynchronously maintaining a consistent replica of a local storage array's first set of input/output operations (IOs);
dynamically define an IO receive cycle based on transmission latency measurements between the local and the one or more remote arrays; and
receive the first set of IOs during a first IO receive cycle of the IO receive cycle at the local storage array;
initiate the first IO receive cycle occurs during a time interval; and
wherein the storage system is located at a first site, and the remote storage arrays are located at a second site.

12. The apparatus of claim 11 further configured to:
establish the time interval based on 1) at least one historical and/or current IO workload received by the storage system and/or 2) a transmission time required to send each IO received during any given IO receive cycle to the one or more remote storage arrays; and
wherein a threshold geographical distance separates the first and second sites.

13. The apparatus of claim 11 further configured to:
transmit a first set of IOs to the one or more remote storage arrays received during a first receive cycle;
receive a response from the one or more remote storage arrays corresponding to the transmitted first set of IOs; and
start a second receive cycle to receive a second set of IOs in response to receiving the response.

14. The apparatus of claim 13 further configured to:
establish a remote data facility (RDF) link between the storage system and the one or more host devices; and
transmit a most recently completed IO cycle to the remote storage arrays via the RDF link.

15. The apparatus of claim 14 further configured to:
configure the remote storage arrays to establish a flash copy of a target storage device, wherein:
the target storage device stores IOs related to one or more of the IO receive cycles, and
the flash copy is established based on a state of the RDF link.

16. The apparatus of claim 15 further configured to:
determine a transmission time of IOs receiving during a receive cycle; and
determine a time required for the one or more remote storage arrays to process IOs related to a receive cycle that is prior to a receiving cycle related to a current transmission of IOs.

17. The apparatus of claim 16 further configured to:
based on the IO transmission and processing times, trigger a receive cycle switch.

18. The apparatus of claim 17 further configured to:
in response to determining that the IO transmission and/or IO processing times are less than a threshold, establish a receive cycle switch interval by:
receiving IOs during an n^{th} receive cycle; and
transmitting IO related to an (n−1) receive cycle, wherein the one or more storage arrays are processing IO related to an (n−2) receive cycle.

19. The apparatus of claim 17 further configured to:
in response to determining that the IO transmission and/or IO processing times are greater than a threshold, establish a receive cycle switch interval by:
receiving an n^{th} receive cycle, an (n−1) receive cycle, and an (n−2) receive cycle; and
transmitting an (n−y) receiving cycle, wherein the one or more storage arrays are processing IO related to an (n−(y−1)) receive cycle.

20. The apparatus of claim 17 further configured to:
determine whether the state of the RDF link corresponds to a disaster event associated with a total loss of the storage system; and
establish the flash copy without pausing IO transmissions to the one or more remote storage arrays.
